(19) United States
(12) Patent Application Publication
(10) Pub. No.: US 2009/0326180 A1
(43) Pub. Date: Dec. 31, 2009

(54) Biodegradable Superabsorbent Particles Containing Cellulose Fiber

(75) Inventor: S. Ananda Weerawarna, Seattle, WA (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: Weyerhaeuser Co., Federal Way, WA (US)

(21) Appl. No.: 12/165,075

(22) Filed: Jun. 30, 2008

(51) Int. Cl. C08H 5/00

(52) U.S. Cl. 527/100

(57) ABSTRACT

A composite fiber comprising cellulose fiber and a fiber comprising a carboxyalkyl cellulose, a starch, and a plurality of non-permanent intra-fiber metal crosslinks. The plurality of non-permanent intra-fiber metal crosslinks are multi-valent metal ion crosslinks formed with one or more metal ions selected from aluminum, boron, bismuth, titanium, and zirconium ions.

### BACKGROUND OF INVENTION

Personal care absorbent products, such as infant diapers, adult incontinent pads, and feminine care products, typically contain an absorbent core that includes superabsorbent polymer particles distributed within a fibrous matrix. Superabsorbents are water-swellable, generally water-insoluble absorbent materials having a high absorbent capacity for body fluids. Superabsorbent polymers (SAPs) in common use are mostly derived from acrylic acid, which is itself derived from petroleum oil, a non-renewable raw material. Acrylic acid polymers and SAPs are generally recognized as not being biodegradable. Despite their wide use, some segments of the absorbent products market are concerned about the use of non-renewable petroleum oil-derived materials and their non-biodegradable nature. Acrylic acid based polymers also comprise a meaningful portion of the cost structure of diapers and incontinent pads. Users of SAP are interested in lower cost SAPs. The high cost derives in part from the cost structure for the manufacture of acrylic acid which, in turn, depends upon the fluctuating price of petroleum oil. Also, when diapers are discarded after use they normally contain considerably less than their maximum or theoretical content of body fluids. In other words, in terms of their fluid holding capacity, they are “over-designed”. This “over-design” constitutes an inefficiency in the use of SAP. The inefficiency results in part from the fact that SAPs are designed to have high gel strength (as demonstrated by high absorbency under load or AUL). The high gel strength (upon swelling) of currently used SAP particles helps them to retain a lot of void space between particles, which is helpful for rapid fluid uptake. However, this high “void volume” simultaneously results in there being a lot of interstitial (between particle) liquid in the product in the saturated state. When there is a lot of interstitial liquid the “rewet” value or “wet feeling” of an absorbent product is compromised.

In personal care absorbent products, U.S. southern pine fluff pulp is commonly used in combination with the SAP. This fluff is recognized worldwide as the preferred fiber for absorbent products. The preference is based on the fluff pulp's advantageous high fiber length (about 2.8 mm) and its relative ease of processing from a wetland pulp sheet to an airlaid web. Fluff pulp is also made from renewable and biodegradable cellulose pulp fibers. Compared to SAP, these fibers are inexpensive on a per mass basis, but tend to be more expensive on a per unit of liquid held basis. These fluff pulp fibers mostly absorb within the interstices between fibers. For this reason, a fibrous matrix readily releases acquired liquid on application of pressure. The tendency to release acquired liquid can result in significant skin wetness during use of an absorbent product that includes a core formed exclusively from cellulosic fibers. Such products also tend to leak acquired liquid because liquid is not effectively retained in such a fibrous absorbent core.

Superabsorbent produced in fiber form has a distinct advantage over particle forms in some applications. Such superabsorbent fiber can be made into a pad form without added non-superabsorbent fiber. Such pads will also be less bulky due to elimination or reduction of the non superabsorbent fiber used. Liquid acquisition will be more uniform compared to a fiber pad with shifting superabsorbent particles.

A need therefore exists for a fibrous superabsorbent material that is simultaneously made from a biodegradable renewable resource like cellulose that is inexpensive. In this way, the superabsorbent material can be used in absorbent product designs that are efficient. These and other objectives are accomplished by the invention set forth below.

### SUMMARY OF THE INVENTION

The present invention superabsorbent fibers containing cellulose fiber. The superabsorbent fibers containing cellulose fiber are composite fibers that include cellulose fiber and a fiber comprising a carboxyalkyl cellulose, a starch, and a plurality of non-permanent intra-fiber metal crosslinks.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a scanning electron microscope photograph (20×) of a representative fibrous superabsorbent composite containing cellulose fiber of the invention (Sample 4, Table 1);

FIG. 2 is a scanning electron microscope photograph (150×) of a representative fibrous superabsorbent composite containing cellulose fiber of the invention (Sample 4, Table 1) (cross-sectional view); and

FIG. 3 is a scanning electron microscope photograph (000×) of a representative fibrous superabsorbent composite containing cellulose fiber of the invention (Sample 4, Table 1) (cross-sectional view).

### DETAILED DESCRIPTION OF THE INVENTION

The present invention superabsorbent fibers containing cellulose fiber. The superabsorbent fibers containing cellulose fiber are composite fibers that include cellulose fiber and a fiber comprising a carboxyalkyl cellulose, a starch, and a plurality of non-permanent intra-fiber metal crosslinks. The superabsorbent fibers containing cellulose fiber are water insoluble and water swellable.

As used herein, the term “superabsorbent fibers containing cellulose fiber” refers to mixed polymer composite fibers formed in accordance with invention (also referred to herein as “mixed polymer composite fibers” or “composite fibers”) that are composed of at least three different polymers (a carboxyalkyl cellulose, a starch, and cellulose fiber). The superabsorbent fibers containing cellulose fiber includes two associated polymers: (1) a carboxyalkyl cellulose and (2) a starch.

The carboxyalkyl cellulose useful in making the superabsorbent fibers containing cellulose fiber has a degree of carboxyl group substitution (DS) of from about 0.3 to about 2.5. In one embodiment, the carboxyalkyl cellulose has a degree of carboxyl group substitution of from about 0.5 to about 1.5. The carboxyalkyl cellulose, which is mainly in the sodium salt form, can be in other salts forms such as potassium and ammonium forms.

Although a variety of carboxyalkyl celluloses are suitable for use in making the composite fibers, in one embodiment, the carboxyalkyl cellulose is carboxymethyl cellulose. In another embodiment, the carboxyalkyl cellulose is carboxyethyl cellulose.

The carboxyalkyl cellulose is present in the composite fiber in an amount from about 60 to about 99% by weight based on the weight of the composite fiber. In one embodiment, the carboxyalkyl cellulose is present in an amount from about 80 to about 95% by weight based on the weight of the composite fiber. In addition to carboxyalkyl cellulose derived from wood pulp containing some carboxyalkyl hemicellulose, carboxyalkyl cellulose derived from non-wood pulp, such as cotton linters, is suitable for preparing the composite fibers. For carboxyalkyl cellulose derived from wood products, the composite fibers include carboxyalkyl hemicellulose in an amount up to about 20% by weight based on the weight of the composite fiber. Suitable carboxyalkyl celluloses include carboxyalkyl celluloses (carboxymethyl cellulose) obtained from commercial sources.

In addition to a carboxyalkyl cellulose, the superabsorbent fibers containing cellulose fiber of the invention include a starch. Starches are composed of two polysaccharides: amylose and amylopectin. Amylose is a linear polysaccharide having an average molecular weight of about 250,000 g/mole. Amylopectin is a branched polysaccharide (branching via 1,6-α-glucosidic links) having an average molecular weight of about 75,000,000 g/mole. Typically, the ratio of amylose to amylopectin is from about 1:4 to about 1:5.

Starches suitable for use in the present invention may be obtained from corn, wheat, maize, rice, sorghum, potato, cassava, barley, buckwheat, millet, oat, arrowroot, beans, peas, rye, tapioca, sago, and amaranth. Also suitable are waxy starches, such as from corn, wheat, maize, rice, sorghum, potato, cassava, and barley. Mixtures of starches can also be used.

Suitable starches for use in the invention include cooked and pre-gelatinized starches. Certain cooked and pre-gelatinized starches are commercially available from a variety of commercial sources.

The preparation of the mixed polymer composite fiber is a multi-step process. In one embodiment, the starch is first cooked ill water (e.g., 75° C. for 45 min). Then cooked aqueous starch is added to an aqueous dispersion of cellulose fiber. Carboxyalkyl cellulose is then added to the aqueous cellulose fiber dispersion with cooked starch and mixed well to form a gel. A first crosslinking agent is added and mixed to obtain a mixed polymer composite gel (crosslinked gel) formed by intermolecular crosslinking of water-soluble polymers containing a dispersion of cellulose fibers.

The starch is present in an amount from about 1 to about 20% by weight based on the weight of the composite fiber. In one embodiment, the starch is present in an amount from about 1 to about 15% by weight based on the weight of the composite fiber.

Cellulose fiber is present in an amount from about 2 to about 15% by weight based on the weight of the mixed polymer composite fiber. In one embodiment, cellulose fiber is present in an amount from about 5 to about 10% by weight based on the weight of the composite fiber.

Although available from other sources, suitable cellulosic fibers are derived primarily from wood pulp. Suitable wood pulp fibers for use with the invention can be obtained from well-known chemical processes such as the kraft and sulfite processes, with or without subsequent bleaching. Pulp fibers can also be processed by thermomechanical, chemithermomechanical methods, or combinations thereof. A high alpha cellulose pulp is also a suitable wood pulp fiber. The preferred pulp fiber is produced by chemical methods. Ground wood fibers, recycled or secondary wood pulp fibers, and bleached and unbleached wood pulp fibers can be used. Softwoods and hardwoods can be used. Suitable fibers are commercially available from a number of companies, including Weyerhaeuser Company. For example, suitable cellulosic fibers produced from southern pine that are usable with the present invention are available from Weyerhaeuser Company under the designations CF416, NF405, PL416, FR516, and NB416. Other suitable fibers include northern softwood and eucalyptus fibers.

The superabsorbent fibers containing cellulose fiber of the invention are made by a method that includes the steps of combining an aqueous dispersion of cellulose fiber and aqueous starch to provide a starch/fiber dispersion; combining the starch/fiber dispersion with a carboxyalkyl cellulose to provide an aqueous gel containing cellulose fiber; treating the aqueous gel containing cellulose fiber with a first crosslinking agent to provide a crosslinked gel containing cellulose fiber; mixing the crosslinked gel containing cellulose fiber with a water-miscible solvent to provide composite fibers containing cellulose fiber; and optionally treating the composite fibers containing cellulose fiber with a second crosslinking agent to provide superabsorbent fibers containing cellulose fiber.

The preparation of the superabsorbent fibers containing cellulose fiber is a multi-step process. In one embodiment, the starch is first cooked in water (e.g., 75° C. for 45 min). Then the aqueous starch is added to a dispersion of cellulose fiber in water and mixed. Then carboxyalkyl cellulose is added to the aqueous cellulose dispersion containing cooked starch and mixed well to obtain a gel. To the gel containing a dispersion of cellulose fiber, first crosslinking agent is added and mixed to obtain a mixed polymer composite gel formed by intermolecular crosslinking of water-soluble polymers.

Suitable first crosslinking agents include crosslinking agents that are reactive towards hydroxyl groups and/or carboxyl groups. Representative crosslinking agents include metallic crosslinking agents, such as aluminum (III) compounds, titanium (IV) compounds, bismuth (III) compounds, boron (III) compounds, and zirconium (IV) compounds. The numerals in parentheses in the preceding list of metallic crosslinking agents refers to the valency of the metal.

The superabsorbent fibers containing cellulose fiber are generated by rapid mixing of the crosslinked gel with a water-miscible solvent. This fiber generated after first crosslinking has a high level of sliminess when hydrated and forms soft gels. Therefore this fiber can be used in certain absorbent applications without further treatment. The fiber generated after first crosslinking (composite fibers containing cellulose fiber) are optionally further crosslinked (e.g., surface crosslinked) by treating with a second crosslinking agent in a water-miscible solvent containing water. The composition of water-miscible solvent and water is such that the fiber does not change its fiber form and return to gel state. The second crosslinking agent can be the same as or different from the first crosslinking agent.

The superabsorbent fibers containing cellulose fiber are insoluble in water while being capable of absorbing water. The fibers are rendered water insoluble by virtue of a plurality of non-permanent intra-fiber metal crosslinks. As used herein, the term “non-permanent intra-fiber metal crosslinks” refers to the nature of the crosslinking that occurs within individual modified fibers (i.e., intra-fiber) and among and between each fiber's constituent polymer molecules (carboxyalkyl cellulose and starch).

The fibers are intra-fiber crosslinked with metal crosslinks. The metal crosslinks arise as a consequence of an associative interaction (e.g., bonding) between functional groups on the fiber's polymers (e.g., carboxy, carboxylate, or hydroxyl groups) and a multi-valent metal species. Suitable multi-valent metal species include metal ions having a valency of three or greater and that are capable of forming interpolymer associative interactions with the functional groups of the polymer (e.g., reactive toward associative interaction with the carboxy, carboxylate, or hydroxyl groups). The polymers are crosslinked when the multi-valent metal species form interpolymer associative interactions with functional groups on the polymers. A crosslink may be formed intramolecularly within a polymer or may be formed intermolecularly between two or more polymer molecules within a fiber. The extent of intermolecular crosslinking affects the water solubility of the composite fibers (i.e., the greater the crosslinking, the greater the insolubility) and the ability of the fiber to swell on contact with an aqueous liquid.

The fibers include non-permanent intra-fiber metal crosslinks formed both intermolecularly and intramolecularly in the population of polymer molecules. As used herein, the term “non-permanent crosslink” refers to the metal crosslink formed with two or more functional groups of a polymer molecule (intramolecularly) or formed with two or more functional groups of two or more polymer molecules (intermolecularly). It will be appreciated that the process of dissociating and re-associating (breaking and reforming crosslinks) the multi-valent metal ion and polymer molecules is dynamic and also occurs during liquid acquisition. During water acquisition the individual fibers and fiber bundles swell and change to gel state. The ability of non permanent metal crosslinks to dissociate and associate under water acquisition imparts greater freedom to the gels to expand than if the gels were restrictively crosslinked by permanent crosslinks that do not have the ability to dissociate and re-associate. Covalent organic crosslinks, such as ether crosslinks, are permanent crosslinks that do not have the ability to dissociate and re-associate.

The carboxyalkyl cellulose and starch containing fibers have fiber widths of from about 2 μm to about 50 μm (or greater) and coarseness that varies from soft to rough.

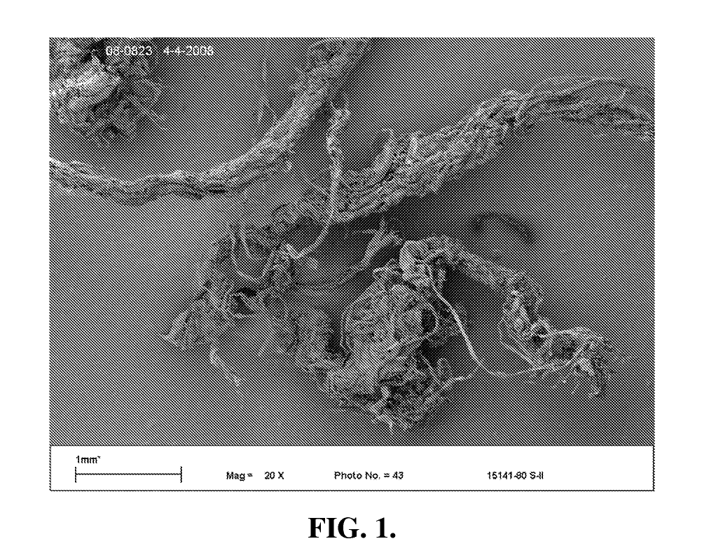

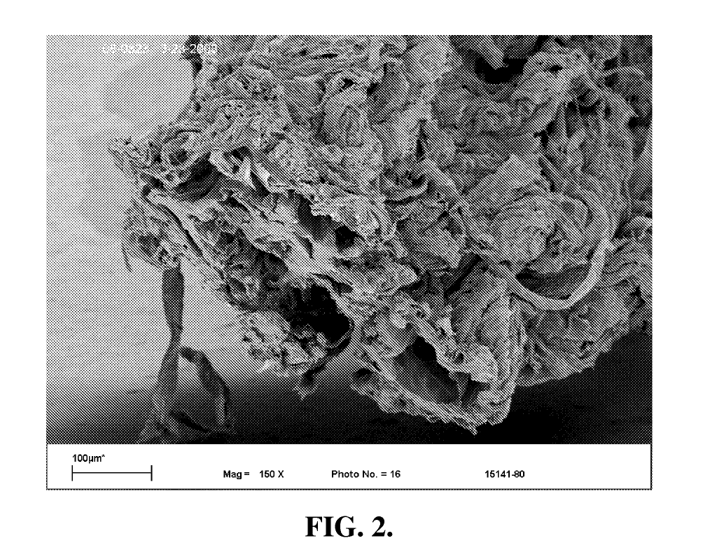

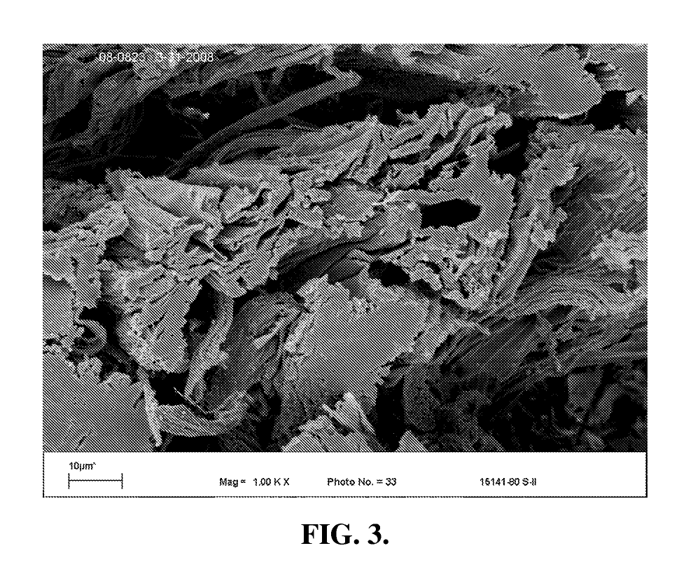

Representative mixed polymer composite fibers (fibrous superabsorbent composite containing cellulose) are illustrated in FIGS. 1-3. FIG. 1 is a scanning electron microscope photograph (20×) of representative superabsorbent fibers containing cellulose of the invention (Sample 4, Table 1). FIG. 2 is a scanning electron microscope photograph (150×) of representative superabsorbent fibers containing cellulose fiber of the invention (Sample 4, Table 1) (cross-sectional view). FIG. 3 is a scanning electron microscope photograph (1000×) of representative superabsorbent fibers containing cellulose fiber of the invention (Sample 4, Table 1) (cross-sectional view).

The superabsorbent fibers containing cellulose fiber are highly absorptive fibers. The fibers have a Free Swell Capacity of from about 30 to about 60 g/g (0.9% saline solution) and a Centrifuge Retention Capacity (CRC) of from about 15 to about 40 g/g (0.9% saline solution).

The fibers can be formed into pads by conventional methods including air-laying techniques to provide fibrous pads having a variety of liquid wicking characteristics. For example, pads absorb liquid at a rate of from about 10 mL/sec to about 0.005 mL/sec (0.9% saline solution/10 mL application). The integrity of the pads can be varied from soft to very strong.

The superabsorbent fibers containing cellulose fiber are water insoluble and water swellable. Water insolubility is imparted to the fiber by intermolecular crosslinking of the mixed polymer molecules, and water swellability is imparted to the fiber by the presence of carboxylate anions with associated cations. The fibers are characterized as having a relatively high liquid absorbent capacity for water (e.g., pure water or aqueous solutions, such as salt solutions or biological solutions such as urine). Furthermore, because the superabsorbent fibers containing cellulose fiber have a fibrous structure, the fibers also possess the ability to wick liquids. The superabsorbent fibers containing cellulose fiber advantageously has dual properties of high liquid absorbent capacity and liquid wicking capacity.

The composite fibers having slow wicking ability of fluids are useful in medical applications, such as wound dressings and others. The composite fibers having rapid wicking capacity for urine are useful in personal care absorbent product applications. The composite fibers can be prepared having a range of wicking properties from slow to rapid for water and 0.9% aqueous saline solutions.

The composite fibers are useful as superabsorbents in personal care absorbent products (e.g., infant diapers, feminine care products and adult incontinence products). Because of their ability to wick liquids and to absorb liquids, the mixed polymer composite fibers are useful in a variety of other applications, including, for example, wound dressings, cable wrap, absorbent sheets or bags, and packaging materials.

The superabsorbent fibers containing cellulose fiber can be made by combining an aqueous dispersion of cellulose fibers and aqueous starch to provide a starch/fiber dispersion; combining the starch/fiber dispersion with a carboxyalkyl cellulose to provide an aqueous gel containing cellulose fiber; treating the aqueous gel containing cellulose fiber with a first crosslinking agent to provide a crosslinked gel containing cellulose fiber; mixing the crosslinked gel containing cellulose fiber with a water-miscible solvent to provide composite fibers containing cellulose fiber; and optionally treating the composite fibers containing cellulose fiber with a second crosslinking agent to provide superabsorbent fibers containing cellulose fiber. The fibers so prepared can be fiberized and dried.

Suitable carboxyalkyl celluloses have a degree of carboxyl group substitution of from about 0.3 to about 2.5, and in one embodiment have a degree of carboxyl group substitution of from about 0.5 to about 1.5. In one embodiment, the carboxyalkyl cellulose is carboxymethyl cellulose. The aqueous dispersion includes from about 60 to about 99% by weight carboxyalkyl cellulose based on the weight of the product composite fiber. In one embodiment, the aqueous dispersion includes from about 80 to about 95% by weight carboxyalkyl cellulose based on the weight of composite fiber. Carboxyalkyl hemicellulose may also be present from about 0 to about 20 percent by weight based on the weight of composite fiber.

Suitable starches are described above. The aqueous dispersion includes from about 1 to about 20% by weight starch based on the weight of the composite fiber, and in one embodiment, the aqueous dispersion includes from about 1 to about 15% by weight starch based on the weight of composite fiber.

The aqueous gel includes cellulose fibers. The gel includes from about 2 to about 15% by weight cellulose fibers based on the weight of the composite fiber, and in one embodiment, the gel includes from about 5 to about 10% by weight cellulose fibers based on the weight of composite fiber.

In the method, the aqueous gel containing cellulose fibers is treated with a first crosslinking agent to provide a crosslinked gel containing cellulose fibers.

Suitable first crosslinking agents include crosslinking agents that are reactive towards hydroxyl groups and carboxyl groups. Representative crosslinking agents include metallic crosslinking agents, such as aluminum (III) compounds, titanium (IV) compounds, bismuth (III) compounds, boron (III) compounds, and zirconium (IV) compounds. The numerals in parentheses in the preceding list of metallic crosslinking agents refers to the valency of the metal.

Representative metallic crosslinking agents include aluminum sulfate; aluminum hydroxide; dihydroxy aluminum acetate (stabilized with boric acid); other aluminum salts of carboxylic acids and inorganic acids; other aluminum complexes, such as Ultrion 8186 from Nalco Company (aluminum chloride hydroxide); boric acid; sodium metaborate; ammonium zirconium carbonate; zirconium compounds containing inorganic ions or organic ions or neutral ligands; bismuth ammonium citrate; other bismuth salts of carboxylic acids and inorganic acids; titanium (IV) compounds, such as titanium (IV) bis(triethylaminato) bis(isopropoxide) (commercially available from the Dupont Company under the designation Tyzor TE); and other titanates with alkoxide or carboxylate ligands.

The first crosslinking agent is effective for associating and crosslinking the carboxyalkyl cellulose (with or without carboxyalkyl hemicellulose) and starch molecules intimately associated with the cellulose fibers. The first crosslinking agent is applied in an amount of from about 0.1 to about 20% by weight based on the total weight of the composite fiber. The amount of first crosslinking agent applied to the polymers will vary depending on the crosslinking agent. In general, the fibers have an aluminum content of about 0.04 to about 0.8% by weight based on the weight of the composite fiber for aluminum crosslinked fibers, a titanium content of about 0.10 to about 1.5% by weight based on the weight of the composite fiber for aluminum crosslinked fibers, a zirconium content of about 0.09 to about 2.0% by weight based on the weight of the composite fiber for zirconium crosslinked fibers, and a bismuth content of about 0.90 to about 5.0% by weight based on the weight of the composite fiber for bismuth crosslinked fibers.

The gel formed by treating the aqueous dispersion of cellulose fibers in the aqueous solution of the carboxyalkyl cellulose and starch with a first crosslinking agent is then mixed with a water-miscible solvent to provide composite fibers. Suitable water-miscible solvents include water-miscible alcohols and ketones. Representative water-miscible solvents include acetone, methanol, ethanol, isopropanol, and mixtures thereof. In one embodiment, the water-miscible solvent is ethanol. In another embodiment, the water-miscible solvent is isopropanol.

The volume ratio of water-miscible solvent added to the aqueous crosslinked gel ranges from about 1:1 to about 1:5 water (the volume used in making the aqueous dispersion of carboxyalkyl cellulose, starch, and cellulose fibers) to water-miscible solvent. Final volume ratio of water to miscible-solvent is from 1:1 to 1:5.

In the method, mixing the gel with the water-miscible solvent includes stirring to provide composite fibers. The mixing step and the use of the water-miscible solvent controls the rate of dehydration and solvent exchange tinder shear mixing conditions and provides for composite fiber formation. Mixing can be carried out using a variety of devices including overhead stirrers, Hobart mixers, British disintegrators, and blenders. For these mixing devices, the blender provides the greatest shear and the overhead stirrer provides the least shear. As noted above, fiber formation results from shear mixing the gel with the water-miscible solvent and effects solvent exchange and generation of composite fiber in the resultant mixed solvent.

In one embodiment, mixing the gel with a water-miscible solvent to provide composite fibers comprises mixing a 1 or 2% solids in water with an overhead mixer or stirrer. In another embodiment, mixing the get with a water-miscible solvent to provide composite fibers comprises mixing 4% solids in water with a blender. For large scale production alternative mixing equipment with suitable mixing capacities are used.

Composite fibers containing cellulose fiber formed from the mixing step are treated with a second crosslinking agent to provide the superabsorbent fibers containing cellulose fiber. The second crosslinking agent is effective in further crosslinking (e.g., surface crosslinking) the composite fibers. Suitable second crosslinking agents include crosslinking agents that are reactive towards hydroxyl groups and carboxyl groups. The second crosslinking agent can be the same as or different from the first crosslinking agent. Representative second crosslinking agents include the metallic crosslinking agents noted above useful as the first crosslinking agents.

The second crosslinking agent is applied at a relatively higher level than the first crosslinking agent per unit mass of fiber. This provides a higher degree of crosslinking on the surface of the fiber relative to the interior of the fiber. As described above, metal crosslinking agents form crosslinks between carboxylate anions and metal atoms or cellulose hydroxyl oxygen and metal atoms. These crosslinks can migrate from one oxygen atom to another when the mixed polymer fiber absorbs water and forms a gel. However, having a higher level of crosslinks on the surface of the fiber relative to the interior provides a superabsorbent fiber with a suitable balance in free swell, centrifuge retention capacity, absorbency under load for aqueous solutions and lowers the gel blocking that inhibits liquid transport.

The second crosslinking agent is applied in an amount from about 0.1 to about 20% by weight based on the total weight of composite fibers. The amount of second crosslinking agent applied to the polymers will vary depending on the crosslinking agent. The product fibers have an aluminum content of about 0.04 to about 2.0% by weight based on the weight of the superabsorbent fibers containing cellulose fiber for aluminum crosslinked fibers, a titanium content of about 0.1 to about 4.5% by weight based on the weight of the superabsorbent fibers containing cellulose fiber for titanium crosslinked fibers, a zirconium content of about 0.09 to about 6.0% by weight based on the weight of the superabsorbent fibers containing cellulose fiber for zirconium crosslinked fibers, and a bismuth content of about 0.09 to about 5.0% by weight based on the weight of the superabsorbent fibers containing cellulose fiber for bismuth crosslinked fibers.

The second crosslinking agent may be the same as or different from the first crosslinking agent. Mixtures of two or more crosslinking agents in different ratios may be used in each crosslinking step.

The preparation of representative superabsorbent fibers containing cellulose fiber are described in Examples 1-3. The absorbent properties of the representative superabsorbent fibers containing cellulose fiber are summarized in the Table 1. In Table 1, “% wgt total wgt, applied” refers to the amount of first crosslinking agent applied to the total weight of CMC and starch, as well as the amount of second crosslinking agent applied to the total weight of CMC, starch, and fibers; “DS” refers to the carboxymethyl cellulose (CMC) degree of substitution; viscosity (cps) refers to Brookfield viscosity determined with spindle #3 at 20 rpm at 25° C.; and “Al₂(SO₄)₃” refers to aluminum sulfate octadecahydrate.

### Test Methods

### Free Swell and Centrifuge Retention Capacities

The materials, procedure, and calculations to determine free swell capacity (g/g) and centrifuge retention capacity (CRC) (g/g) were as follows.

Test Materials:

Japanese pre-made empty tea bags (available from Drugstore.com, IN PURSUIT OF TEA polyester tea bags 93 mm×70 mm with fold-over flap. (http:www.mesh.ne.jp/tokiwa/)).

Balance (4 decimal place accuracy, 0.0001 g for air-dried superabsorbent polymer (ADS SAP) and tea bag weights); timer; 1% saline; drip rack with clips (NLM 211); and lab centrifuge (NLM 211, Spin-X spin extractor, model 776S, 3,300 RPM, 120 v).

Test Procedure;

1. Determine solids content of ADS.

2. Pre-weigh tea bags to nearest 0.0001 g and record.

3. Accurately weigh 0.2025 g ±0.0025 g of test material (SAP), record and place into pre-weighed tea bag (air-dried (AD) bag weight). (ADS weight+AD bag weight=total dry weight).

4. Fold tea bag edge over closing bag.

5. Fill a container (at least 3 inches deep) with at least 2 inches with 1% saline.

6. Hold tea bag (with test sample) flat and shake to distribute test material evenly through bag.

7. Lay tea bag onto surface of saline and start timer.

8. Soak bags for specified time (e.g., 30 minutes).

9. Remove tea bags carefully, being careful not to spill any contents from bags, hang from a clip on drip rack for 3 minutes.

10. Carefully remove each bag, weigh, and record (drip weight).

11. Place tea bags onto centrifuge walls, being careful not to let them touch and careful to balance evenly around wall.

12. Lock down lid and start timer. Spin for 75 seconds.

13. Unlock lid and remove bags. Weigh each bag and record weight (centrifuge weight).

Calculations:

The tea bag material has an absorbency determined as follows:

Free Swell Capacity, factor=5.78

Centrifuge Capacity, factor=0.50

Z=Oven dry SAP wt (g)/Air dry SAP wt (g)

Free Capacity (g/g):

$$\frac{\begin{matrix}[ ( drip wt ( g ) - dry bag wt ( g ) ) - ( AD SAP wt ( g ) ) ] - \\ ( dry bad wt ( g ) * 5.78 )\end{matrix}}{( AD SAP wt ( g ) * Z )}$$

Centrifuge Retention Capacity (g/g):

$$\frac{\begin{matrix}[ centrifuge wt ( g ) - dry bag wt ( g ) - ( AD SAP wt ( g ) ) ] - \\ ( dry wt ( g ) * 0.50 )\end{matrix}}{( AD SAP wt * Z )}$$

The following examples are provided for the purpose of illustrating, not limiting, the invention.

### EXAMPLES

### Example 1

### The Preparation of Representative Superabsorbent Fibers Containing Cellulose Fiber: Aluminum Sulfate Crosslinking

In this example, the preparation of representative superabsorbent fibers containing cellulose fiber crosslinked with aluminum sulfate is described.

Corn starch (Clinton 185®, Archer Daniel Midland, IL) (1.8 g) was cooked for 45 minutes at 75° C. in 43 mL deionized water. The cooked starch was then added to 907 mL deionized water in a Hobart mixer. Cellulose fibers (NB 416 fluff pulp, Weyerhaeuser Company, WA) (3.0 g) was added to the aqueous starch mixture. Then, carboxymethyl cellulose (30 g OD northern pine wood pulp CMC, DS 1,03, 1% aqueous solution, Brookfield viscosity 1465 cps, spindle #3 and speed 20 rpm) was added with mixing. The aqueous polymer mixture was mixed for 60 minutes.

To the aqueous polymer mixture was added 1.0 g aluminum sulfate octadecahydrate (Sigma Aldrich, WI) in deionized water. The polymer mixture was then mixed for 30 minutes to provide a crosslinked polymer gel.

The crosslinked polymer gel was then transferred to a Waring blender. Isopropanol (500 mL) was added and the combination mixed at 3000 rpm for 2 minutes. An additional 2.5 L isopropanol was added and the combination mixed for 1 minute at 2500 rpm. The resulting fiber slurry was collected by filtration.

The fiber slurry was added to a solution of aluminum sulfate octadecahydrate (2.2 g) (Sigma Aldrich, WI) in 50 mL water and 4 L 75% isopropanol and mixed for 15 minutes. The fiber slurry was collected by filtration and the collected fibers stirred in a solution of 950 mL isopropanol, 40 mL water, and 10 mL glycerol for 2 minutes. The product fibers were collected by filtration and air dried. The fibers had free swell (43.0 g/g) and centrifuge retention capacity (20.5 g/g) for 0.9% saline solution.

### Example 2

### The Preparation of Representative Superabsorbent Fibers Containing Cellulose Fiber: Aluminum Sulfate Crosslinking

In this example, the preparation of representative superabsorbent fibers containing cellulose fiber crosslinked with aluminum sulfate is described.

Corn starch (Clinton 185®, Archer Daniel Midland, IL) (1.8 g) was cooked for 45 minutes at 75° C. in 50 mL deionized water. The cooked starch was then added to 900 mL deionized water in a Hobart mixer. Cellulose fibers (NB 416 fluff pulp, Weyerhaeuser Company, WA) (3.0 g) was added to the aqueous starch mixture. Then, carboxymethyl cellulose (30 g OD northern pine wood pulp CMC, DS 1.03, 1% aqueous solution, Brookfield viscosity 1465 cps, spindle #3 and speed 20 rpm) was added with mixing. The aqueous polymer mixture was mixed for 60 minutes.

To the aqueous polymer mixture was added 1.2 g aluminum sulfate octadecahydrate (Sigma Aldrich, WI) in deionized water. The polymer mixture was then mixed for 30 minutes to provide a crosslinked polymer gel.

The crosslinked polymer gel was then transferred to a Waring blender. Isopropanol (500 mL) was added and the combination mixed at 3000 rpm for 2 minutes. An additional 2.5 L isopropanol was added and the combination mixed for 1 minute at 2500 rpm. The resulting fiber slurry was collected by filtration.

The fiber slurry was added to a solution of aluminum sulfate octadecahydrate (1.8 g) (Sigma Aldrich, WI) in 50 mL water and 4 L 75% isopropanol and mixed for 15 minutes. The fiber slurry was collected by filtration and the collected fibers stirred in a solution of 950 mL isopropanol, 40 mL water, and 10 mL glycerol for 2 minutes. The product fibers were collected by filtration and air dried. The fibers had free swell (39.6 g/g) and centrifuge retention capacity (19.5 g/g) for 0.9% saline solution.

### Example 3

### The Preparation of Representative Superabsorbent Fibers Containing Cellulose Fiber: Aluminum Sulfate Crosslinking

In this example, the preparation of representative superabsorbent fibers containing cellulose fiber crosslinked with aluminum sulfate is described.

Corn starch (Clinton 185®, Archer Daniel Midland, IL) (0.6 g) was cooked for 45 minutes at 75° C. in 31 mL deionized water. The cooked starch was then added to 919 mL deionized water in a Hobart mixer. Cellulose fibers (NB 416 fluff pulp, Weyerhaeuser Company, WA) (1.0 g) was added to the aqueous starch mixture. Then, carboxymethyl cellulose (10 g OD northern pine wood pulp CMC, DS 0.93, 1% aqueous solution, Brookfield viscosity 1350 cps, spindle #3 and speed 20 rpm) was added with mixing. The aqueous polymer mixture was mixed for 60 minutes.

To the aqueous polymer mixture was added 0.4 g aluminum sulfate octadecahydrate (Sigma Aldrich, WI) in deionized water. The polymer mixture was then mixed for 30 minutes to provide a crosslinked polymer gel.

The crosslinked polymer gel was then transferred to a Waring blender. Isopropanol (500 mL) was added and the combination mixed at 3000 rpm for 2 minutes. An additional 2.5 L isopropanol was added and the combination mixed for 1 minute at 2500 rpm. The resulting fiber slurry was collected by filtration.

The fiber slurry was added to a solution of aluminum sulfate octadecahydrate (1.2 g) (Sigma Aldrich, WI) in 50 mL water and 4 L 75% isopropanol and mixed for 15 minutes. The fiber slurry was collected by filtration and the collected fibers stirred in a solution of 1.0 L 90% isopropanol for 1 minute. The product fibers were collected by filtration and air dried. The fibers had free swell (44.9 g/g) and centrifuge retention capacity (22.7 g/g) for 0.9% saline solution.

TABLE 1
Compositions and Absorbent Properties of Precipitated Superabsorbent Fiber
From Crosslinked Aqueous Mixtures of CMC, Starch, and Cellulose Fiber

| | | | | First | Second | | |
|---|---|---|---|---|---|---|---|
| | CMC | | | crosslinking | crosslinking | | |
| | (DS, | Starch | Cellulose | agent | agent | Free | |
| | viscosity, | (wgt % | (wgt % total | (wgt % total | (wgt % total | Swell | CRC |
| Sample | %) | total wgt) | wgt) | wgt, applied) | wgt, applied) | (g/g) | (g/g) |
| 1 | 1.03, | 5.0 | 8.2 | Al₂(SO₄)₃ 1.4 | Al₂(SO₄)₃ 3.0 | 43.0 | 20.5 |
| | 1465, 82.4 | | | | | | |
| 2 | 1.03, | 4.9 | 8.2 | Al₂(SO₄)₃ 1.9 | Al₂(SO₄)₃ 3.4 | 43.8 | 20.8 |
| | 1465, 81.6 | | | | | | |
| 3 | 1.03, | 5.0 | 8.2 | Al₂(SO₄)₃ 1.7% | Al₂(SO₄)₃ 2.5 | 39.6 | 19.5 |
| | 1465, 82.6 | | | | | | |
| 4 | 0.93, | 4.8 | 8.1 | Al₂(SO₄)₃ 1.6% | Al₂(SO₄)₃ 4.8 | 44.9 | 22.7 |
| | 1370, 80.7 | | | | | | |

While illustrative embodiments have been illustrated and described, it will be appreciated that various changes can be made therein without departing from the spirit and scope of the invention.

The embodiments of the invention in which an exclusive property or privilege is claimed are defined as follows:

1. A composite fiber, comprising cellulose fiber and a fiber comprising a carboxyalkyl cellulose, a starch, and a plurality of non-permanent intra-fiber metal crosslinks.

2. The fiber of claim 1, wherein the carboxyalkyl cellulose has a degree of carboxyl group substitution of from about 0.3 to about 2.5.

3. The fiber of claim 1, wherein the carboxyalkyl cellulose is carboxymethyl cellulose.

4. The fiber of claim 1, wherein the starch is selected from the group consisting of corn, wheat, maize, rice, sorghum, potato, cassava, barley, buckwheat, millet, oat, arrowroot, beans, peas, rye, tapioca, sago, and amaranth starches.

5. The fiber of claim 1, wherein the starch is corn starch.

6. The fiber of claim 1, wherein the carboxyalkyl cellulose is present in an amount from about 60 to about 99 percent by weight based on the total weight of the fiber.

7. The fiber of claim 1, wherein the starch is present in an amount from about 1 to about 20 percent by weight based on the total weight of the fiber.

8. The fiber of claim 1, wherein the cellulose fiber is present in an amount from about 2 to about 15 percent by weight based on the total weight of the fiber.

9. The fiber of claim 1, wherein the non-permanent intra-fiber metal crosslinks comprise multi-valent metal ion crosslinks.

10. The fiber of claim 9, wherein the multi-valent metal ion crosslinks comprise one or more metal ions selected from the group consisting of aluminum (III) compounds, titanium (IV) compounds, bismuth (III) compounds, boron (III) compounds, and zirconium (IV) compounds.

11. The fiber of claim 1 having a free swell capacity of from about 30 to about 60 g/g for 0-9% saline solution.

12. The fiber of claim 1 having a centrifuge retention capacity of from about 15 to about 40 g/g for 0.9% saline solution.

13. The fiber of claim 1 having a wicking rate of from about 10 mL/sec to about 0.005 mL/sec for 0.9% saline solution.

14. The fiber of claim 1 having a centrifuge retention capacity of from about 15 to about 35 g/g for 0.9% saline solution and a wicking rate of from about 10 mL/sec to about 0.005 mL/sec for 0.9% saline solution.
